(19) United States
(12) Patent Application Publication
(10) Pub. No.: US 2012/0319428 A1
(43) Pub. Date: Dec. 20, 2012

(54) Segmented Skirt Aerodynamic Fairing Device for Reducing the Aerodynamic Drag of Ground Vehicles

(76) Inventor: Richard Wood, Virginia Beach, VA (US)

(21) Appl. No.: 13/478,865

(22) Filed: May 23, 2012

Related U.S. Application Data
(60) Provisional application No. 61/488,856, filed on May 23, 2011.

(51) Int. Cl. B62D 35/00

(52) U.S. Cl. 296/180.4

(57) ABSTRACT

A method and device for reducing aerodynamic drag and improving performance and stability of ground vehicles by reducing the mass and velocity of the flow passing under a vehicle is described. The device is suitable for use with a truck and trailer system but may also be applied to a single unit truck system or any combination vehicle that includes a motorized lead vehicle pulling one or more non-motorized vehicles. The device includes right forward and aft panels configured to attach to a lower right portion of the vehicle such that they extend downward from the undercarriage region. The device further includes left forward and aft panels configured to attach to a lower left portion of the vehicle such that they extend downward from the undercarriage region. The device minimizes and controls airflow entering the undercarriage region from the front and sides of the ground vehicle.

### CROSS-REFERENCE TO RELATED APPLICATION

This application claims the benefit of U.S. provisional application Ser. No. 61/488,856, filed May 23, 2011 and entitled “Segmented Skirt Aerodynamic Fairing Device and Method for Reducing the Aerodynamic Drag of Ground Vehicles,” the disclosure of which is incorporated herein by reference.

### GOVERNMENT SUPPORT

The invention described herein was made by employees of the United States Government, and may be manufactured and used by or for the Government without payment of any royalties thereon or therefore.

### FIELD OF INVENTION

The invention relates generally to the reduction of aerodynamic drag for moving ground vehicles, and specifically to an improved method and device for the reduction of aerodynamic drag of ground vehicles by reducing the mass and velocity of the flow passing under a vehicle.

### BACKGROUND OF THE INVENTION

The air flow passing under a ground vehicle imparts a drag force to the vehicle when it impinges on and flows around the vehicle undercarriage components, landing gear, axles, brake components, mud flap systems, wheel wells and fenders, wheels, tires and various other vehicle components attached to or a part of the underside of a vehicle. The focus is on all ground vehicles that may be either a single non-articulating type or a multi component vehicle that articulates. An articulating ground vehicle typically consists of a motorized lead vehicle pulling one or more non-motorized vehicles. The present invention is designed to minimize and control the flow entering the undercarriage region from the side of a ground vehicle or ground vehicle component.

There have been several attempts to reduce the aerodynamic drag associated with the undercarriage and wheel systems of ground vehicles. Undercarriage and wheel system drag may comprise 25 percent of the total vehicle drag.

The undercarriage is comprised of all components located on the underside of the vehicle and includes the vehicle wheels, axles, brake system, frame structure, etc. The flow passing around ground vehicle enters the undercarriage region from the side of the vehicle or vehicle component. The undercarriage flow is characterized as unsteady and dynamic and comprised of various size and strength eddy currents. The unsteady nature of the undercarriage flow is a result of the flow interacting with the ground or road, rotating wheels, brake systems, axles, and the various components comprising the vehicle or vehicle component lower surface. Relative to the free stream static pressure, the undercarriage flow imparts an increased pressure on surfaces that face forward and a decreased pressure on surfaces that face aft. The increase in pressure acting on the forward-facing surfaces and the decreased pressure acting on the aft-facing surfaces both generate an aerodynamic drag force. It is estimated that the pressures acting on the wheel assembly accounts for one-half of the undercarriage drag, with the remaining drag being attributed to the flow interacting with numerous small structures comprising the remaining undercarriage systems. Previous attempts have addressed the undercarriage drag by installing either spanwise or streamwise aerodynamic fairings to the underside to either divert undercarriage flow from the wheel assembly or to block flow from entering the undercarriage region from the side. The flow diverter devices are spanwise fairings that mount to the undercarriage immediately forward of the wheel assembly. The flow diverter fairings are angled downward or outward to divert the undercarriage flow from the wheel assembly. The flow blocking devices are streamwise fairings that mount beneath the vehicle outside edge forward of the aft most wheel assembly and rearward of the forward most wheel system. Both types of fairings show increased benefit with increased vertical extent of the fairing.

Conventional approaches have used the flow diverter undercarriage fairings to reduce the mass of undercarriage flow that impinges onto the wheel assembly, as shown in U.S. Pat. Nos. 4,386,801, 4,486,046, 4,640,541 and 6,794,178. These representative fairing devices, while successful in reducing the mass of flow impinging on the wheel assembly and thereby reducing the wheel assembly drag, do not significantly affect the undercarriage drag. The limited effectiveness of these devices is a result of the drag generated by the device, referred to as device drag. The device drag for these fairings may be equal to the wheel assembly drag. These devices only reduce the wheel assembly drag and do not reduce the remaining undercarriage drag associated with the various components.

Other approaches have used the undercarriage side fairings to reduce the mass and velocity of the flow entering the undercarriage region, as shown in U.S. Pat. Nos. 4,611,847, 4,746,160, 5,280,990, 5,921,617, and 6,644,720. These representative flow blocking devices, while successful in reducing the mass of flow entering the undercarriage region are either simple rigid structures or they are complex active, flexible and variable geometry systems. The simple devices are designed to have a limited vertical and longitudinal extent in order to reduce the impact on operations and maintenance. Limiting the vertical and longitudinal extent of the device significantly reduces the flow blocking capability and results in a minimal aerodynamic drag reduction benefit. The complex devices typically have features that are active, flexible, and/or variable in order to maximize the flow blocking capability while minimizing the impact on operations. The complex devices typically consist of multiple components. The complexity of these devices results in increased weight, maintenance, and cost. Each of the undercarriage flow blocking devices consists of a vertically extended structure that attaches to the lower surface outer side edges of a vehicle or vehicle component. These devices are held in position by various support and bracing structures that are integrated into or attached to the inward facing surface of the flow blocking structure. The support and bracing structures add additional forward and rearward facing undercarriage elements that contribute to the undercarriage drag. These support and bracing structures also collect debris, snow and ice during operation resulting in an increase in maintenance and repair requirements.

### SUMMARY OF THE INVENTION

The invention relates to an aerodynamic fairing device for reducing the aerodynamic drag on a ground vehicle. The device includes a first panel system located on the left side of the vehicle and positioned between the vehicle lower surface and the road surface, including a first forward panel system that has minimal forward projected area and one or more first aft panel systems that has minimal forward projected area and are located aft of the first forward panel system. A second panel system may be located on the right side of the vehicle and positioned between the vehicle lower surface and the road surface, including a second forward panel system that has minimal forward projected area and one or more second aft panel systems that have minimal forward projected area and is located aft of the second forward panel system. The first and second panel systems located on the left and right side of the vehicle respectively are each comprised of multiple separate panel systems with a forward panel system and one or more aft panel systems, where the forward panel system has minimal forward projected area and the one or more aft panel systems have minimal forward projected area, or the first and second forward panel systems and the first and second aft panel systems may each be comprised of multiple longitudinal segments comprising the first and second forward panel system and one or more first and second aft panel system. The first and second forward panel system is located substantially forward of the associated first and second aft panel systems and is rigidly attached to the vehicle and held at a fixed longitudinal position relative to the vehicle. The first and second aft panel systems are positioned longitudinally aft of the forward panel system. If the device is installed on a trailer with a sliding bogie, one of the first and second aft panel system is rigidly attached to the sliding bogie system such that the subject aft panel system will move longitudinally with the bogie system. Each first and second panel system typically extends downward from the horizontal plane of the vehicle lower surface a distance less than 99% of the distance from the lower surface of the vehicle to the surface that the vehicle is moving over. Each first and second panel system may extend downward a substantially equal distance from the bottom surface of the vehicle, the shape and distance of the downward extension may vary along the length of each first and second panel system.

In one embodiment the panels may be an integral extension of the side surface of the vehicle. The panels may have various profiles, such as a swept leading or trailing edges. In another embodiment, the panels are connected to the vehicle such that the panels may be folded so as to be substantially adjacent and proximate the bottom surface of the vehicle when not in use. In another embodiment, the panels are connected to the vehicle such that the panels may be folded so as to be substantially adjacent and proximate the side surface of the vehicle when not in use. In still another embodiment, the panels are connected to the vehicle such that the panels may be slid forward or aft so as to be substantially adjacent to each other when not in use. The panels may also be slidably connected to the vehicle such that the panels slide longitudinally along the vehicle. The distance between at least one of the first or second pairs of panels may be adjustable.

One functional aspect of the device is to prohibit flow from entering the undercarriage region and interacting with the complex geometry of the undercarriage and wheel assembly by creating two similar structures that attach to the underside or the sides of the vehicle. The two similar panel systems of the present apparatus are light-weight aerodynamic fairings that attach to the structure of a ground vehicle that may be a single unit, un-articulated, ground vehicle or a component of an articulated ground vehicle such as a trailer. The left and right side panel systems of the apparatus may attach to the vehicle near the outside edges of the vehicle or vehicle component. The left and right side panel systems are two similar structures that mount to the right and left side of a vehicle and are of minimum vertical extent where each left and each right side panel system include a forward portion and a rear portion that attach to the vehicle. The first and second aft panel system can be positioned in a manner to cover the outer facing surface of the aft most tire and wheel system of a vehicle and the first and second forward panel system is substantially forward of and separated from the respective first and second aft potion of each panel system. Alternatively, the first and second aft panel systems can be positioned such that the rear edges of the first and second aft panel system are located forward of, and in close proximity to, the forward portion of the aft-most tire and wheel systems such that the aft panel systems do not obstruct lateral access to tire and wheel systems. Each aft panel system may extend vertically downward as close as practical to the ground based upon operational and maintenance criteria. Each panel system is located longitudinally between the aft end of the vehicle or vehicle component and the vehicle forward wheel assembly. Each structure is variable in length and is capable of covering a variable longitudinal distance between the vehicle aft end and the vehicle forward wheel assembly.

The flow blocking performance of each of the two panel systems is enhanced through the effective use of ground effect interference. Each of the two panel systems accomplishes the flow control and drag reduction goals with a vertically orientated surface that has an aft panel system and a forward panel system. The forward and aft panel systems of each structure may be of similar or varying longitudinal and vertical length.

Each left side and right side panel system is comprised of a forward panel system and one or more aft panel systems. The one or more aft panel systems and the forward panel system of each left side and each right side panel system may be divided into multiple segments to address installation, maintenance, and operational concerns. A segment may be comprised of a single sub-panel and a means to rigidly attach the sub-panel to the vehicle or adjacent panels. The forward panel system of each panel system is shaped to meet the operational, maintenance, and performance needs of the user. Each aft panel segment of each panel system is orientated and shaped to meet the operational, maintenance, and performance needs of the user. The left and right structures may allow longitudinal adjustment of the aft panel system with a slide engagement between panel segments of the aft panel system.

The forward panel system of each structure is designed to control flow from entering the undercarriage region by redirecting the flow over aerodynamically shaped surfaces of the forward panel system and away from the undercarriage region. The forward panel system may also be designed to redirect residual flow inboard over aerodynamically contoured surfaces that will control the flow to minimize drag. The longitudinal position of the forward panel system is critical to maximizing the flow control benefit while minimizing the aerodynamic drag force acting on the forward panel system. One or more of the aft panel systems of each panel system is designed to block flow from impinging on the aft wheel system, bogie and undercarriage structure. The flow control strategy allows the device to block a significantly greater mass of flow from entering the undercarriage region compared to a typical single panel fairing of equal weight and surface area.

In certain embodiments, an apparatus for reducing the aerodynamic drag of a vehicle trailer body is provided. The trailer body has a bottom defining an undercarriage region, a left side defining a left side surface, a right side defining a right side surface, the trailer further including a right aft-most wheel assembly, a left aft-most wheel assembly, and a sliding bogie configured to permit the right and left wheel assemblies to be slid longitudinally with respect to the trailer body. The trailer body is configured for transport over a road surface. The apparatus includes a substantially rectangular left forward panel having a width (LFPH) and a length (LFPL), a substantially rectangular left aft panel having a width (LAPH) and a length (LAPL), a substantially rectangular right forward panel having a width (RFPH) and a length (RFPL), and a substantially rectangular right aft panel having a width (RAPH) and a length (RAPL). The left aft panel and left forward panel are configured to attach to a lower left portion of the trailer such that they extend downward from the undercarriage region. The left forward panel is positioned forward of the left aft panel. The left aft panel and the left forward panel are approximately parallel to the left side surface of the trailer. The right aft panel and right forward panel are configured to attach to a lower right portion of the trailer such that they extend downward from the undercarriage region. The right forward panel is positioned forward of the right aft panel. The right aft panel and the right forward panel are approximately parallel to the right side surface of the trailer. The width of each of the panels is less than or equal to about 95% of a distance between the trailer bottom surface and the road surface. The left aft panel and the right aft panel are secured to the sliding bogie such that they move longitudinally with the sliding bogie. The left aft panel is positioned longitudinally such that a forward edge of the left aft panel is located forward of the left wheel assembly. The right aft panel is positioned longitudinally such that a forward edge of the right aft panel is located forward of the right wheel assembly. The left forward panel and the left aft panel are separated longitudinally so as to define a first gap having a length (LGL) that is greater than about 6 inches. The right forward panel and the right aft panel being separated longitudinally so as to define a second gap having a length (RGL) that is greater than about 6 inches. The apparatus is configured to reduce aerodynamic drag on the trailer by reducing airflow entering the undercarriage region from the sides of the trailer when the trailer is moving in a forward direction over the road surface.

In certain embodiments, the left forward panel and the right forward panel are configured to be positioned in a mirror-image configuration with respect to one another about an axis defined by a centerline running longitudinally through the trailer body. The right aft panel may be positioned longitudinally such that a rear edge of the right aft panel is located forward of, and in close proximity to, the forward portion of the right wheel assembly such that the right aft panel does not obstruct lateral access to the right wheel assembly. The left aft panel may be positioned longitudinally such that a rear edge of the left aft panel is located forward of, and in close proximity to, the forward portion of the left wheel assembly such that the left aft panel does not obstruct access to the left wheel assembly. The length (LFPL) of the left forward panel, the length (LAPL) of the left aft panel, and the length (LGL) of the first gap together define a total left length (TLL). The total left length (TLL) may be greater than or equal to about 30% of a trailer body length (BL). The length (RFPL) of the right forward panel, the length (RAPL) of the right aft panel, and the length (RGL) of the second gap together define a total right length (TRL). The total right length (TRL) may be greater than or equal to about 30% of the trailer body length (BL).

In certain embodiments, the length (LAPL) of the left aft panel and the length (RAPL) of the right aft panel may each be any of the following suitable dimensions: greater than or equal to about 4 feet, about 6 feet, or greater than about 6 feet. In certain embodiments, the length (LFPL) of the left forward panel and the length (RFPL) of the right forward panel may beach be any of the following suitable dimensions: greater than or equal to about 12 feet or greater than or equal to about 16 feet. In certain embodiments, the length (RGL) of the second gap and the length (LGL) of the first gap may each be greater than or equal to about 2 feet, 4 fet, or 6 feet.

In certain embodiments, the right forward panel and the left forward panel may each be configured to slide longitudinally with respect to the trailer body to change their position. In certain embodiments, a forward portion of the right aft panel and a forward portion of the left aft panel may each be curved laterally inward so as to extend at least partially into the undercarriage region. In such embodiments, the forward portions may each define a forward-facing surface configured to divert air flow laterally outward from underneath the undercarriage region when the trailer is moving in a forward direction over the road surface. In certain embodiments, the right aft panel may be substantially parallelogram-shaped so that a bottom edge of the right aft panel is longitudinally offset aft from a top edge of the right aft panel. Similarly, the left aft panel may be substantially parallelogram-shaped so that a bottom edge of the left panel is longitudinally offset aft from a top edge of the left aft panel.

In certain embodiments, the apparatus may include a third substantially rectangular right panel and a third substantially rectangular left panel. The third right panel may be positioned forward of the right forward panel such that a gap having a length of at least about 6 inches is formed therebetween. The third left panel may be positioned forward of the left forward panel such that a gap having a length of at least about 6 inches is formed therebetween. Each of the third panels may be, for example, about 4 feet, about 6 feet, about 8 feet, or greater than about 8 feet in length. Other suitable dimensions may also be used. In certain embodiments, the combined length of the third left panel and the left forward panel may be between about 12 feet and about 18 feet. In certain embodiments, the combined length of the third right panel and the right forward panel may be between about 12 feet and about 18 feet.

In certain embodiments, each of the panels may be configured to attach to the bottom of the trailer. In other embodiments, the panels may be configured to attach to the trailer's side surfaces. The apparatus may include a plurality of angled brackets configured to attach to the bottom of the trailer and secure a corresponding panel in place. In certain embodiments, an apparatus for reducing the aerodynamic drag of a ground vehicle is provided. The ground vehicle has a body including a bottom defining an undercarriage region, a left side defining a left side surface, a right side defining a right side surface. The vehicle further includes a right aft-most wheel assembly and a left aft-most wheel assembly. The vehicle is configured for transport over a road surface. The apparatus includes a substantially rectangular left forward panel having a width (LFPH) and a length (LFPL), a substantially rectangular left aft panel having a width (LAPH) and a length (LAPL), a substantially rectangular right forward panel having a width (RFPH) and a length (RFPL), a substantially rectangular right aft panel having a width (RAPH) and a length (RAPH). The left aft panel and left forward panel are configured to attach to a lower left portion of the vehicle body and extend downward from the undercarriage region. The left forward panel is positioned forward of the left aft panel. The left aft panel and the left forward panel are approximately parallel to the left side surface of the vehicle body. The right aft panel and right forward panel are configured to attach to a lower right portion of the vehicle and extend downward from the undercarriage region. The right forward panel is positioned forward of the right aft panel. The right aft panel and the right forward panel are approximately parallel to the right side surface of the vehicle body. The width of each of the panels is less than or equal to about 95% of a distance between the vehicle bottom surface and the road surface. The left aft panel is positioned longitudinally such that a forward edge of the left aft panel is located forward of the left wheel assembly. The right aft panel is positioned longitudinally such that a forward edge of the right aft panel is located forward of the right wheel assembly. The left forward panel and the left aft panel are longitudinally separated by a gap having a length (LGL) that is greater than about 6 inches. The right forward panel and the right aft panel are longitudinally separated by a gap having a length (RGL) that is greater than about 6 inches. The apparatus is configured to reduce aerodynamic drag on the vehicle by reducing airflow entering the undercarriage region from the sides of the vehicle body when the trailer is moving in a forward direction over the road surface.

### BRIEF DESCRIPTION OF THE DRAWINGS

The device will be better understood in relation to the attached drawings illustrating preferred embodiments, wherein:

FIG. 1A is a front oblique view of a prior art single unit non-articulated truck.

FIG. 1B is a side view of a prior art single unit non-articulated truck.

FIG. 2A is a cross section view of the flow features under a prior art single unit truck.

FIG. 2B is a cross section view of the flow features under a single unit truck with the device installed.

FIG. 3A is a front oblique view of a single unit non-articulated truck with the device installed.

FIG. 3B is a side view of a single unit non-articulated truck with the device installed.

FIGS. 4A-4E are side views of a single unit truck with the device installed showing representative panel concepts.

FIGS. 5A-5C is a side view of a single unit truck with the device installed with variations in the panel shapes.

FIG. 6A is a front oblique view of a single unit non-articulated truck showing the front portion and aft portion of the device installed.

FIG. 6B is a lower surface view of a single unit non-articulated truck showing the front portion and aft portion of the device installed.

FIGS. 7A-7C are lower surface views of a single unit truck with the device installed showing representative longitudinal shaping of the forward and aft panels.

FIGS. 8 is a side view and sections views of a single unit truck with the device installed showing representative vertical shaping of the forward and aft panels.

FIG. 9 is a side view and section views of a single unit truck with the device installed showing representative panel structural concepts.

FIG. 10 is a side view and section view of a single unit truck with the device installed showing a representative structural support concept.

FIG. 11A is a side view of a single unit truck with the device installed showing alternate lower edge concepts.

FIG. 11B are section views of the lower edge of the forward and aft panel of the device showing alternate lower edge concepts.

FIG. 12A is a side view and lower surface view of a prior art tractor trailer combination vehicle.

FIGS. 12B-12D are side and lower surface views of a tractor trailer combination vehicle with the device installed showing representative longitudinal shaping of the forward and aft panels.

FIGS. 12E-F are side and lower surface views of a tractor trailer combination vehicle with the device installed showing representative multiple panel arrangements.

FIGS. 13A-13C are side views of a tractor trailer combination with the device installed showing the trailer's slider in respectively its forward-most position, mid-position, and aft-most position.

### DETAILED DESCRIPTION OF THE PREFERRED EMBODIMENTS

The following descriptions are of exemplary embodiments only, and are not intended to limit the scope, applicability or configuration of the invention in any way. Rather the following description is intended to provide a convenient illustration for implementing various embodiments of the invention. As will become apparent, various changes may be made in the function and arrangement of the elements described herein without departing from the spirit and scope of the invention. For example, though not specifically described, many shapes, widths, leading edge shapes, spacing and orientation of the aft portion and forward portion of the structure and panels, candidate vehicles that can benefit from the device, fabrication means and material, attachments means and material should be understood to fall within the scope of the present approach.

Referring now in detail to the drawings, like numerals herein designate like numbered parts in the figures.

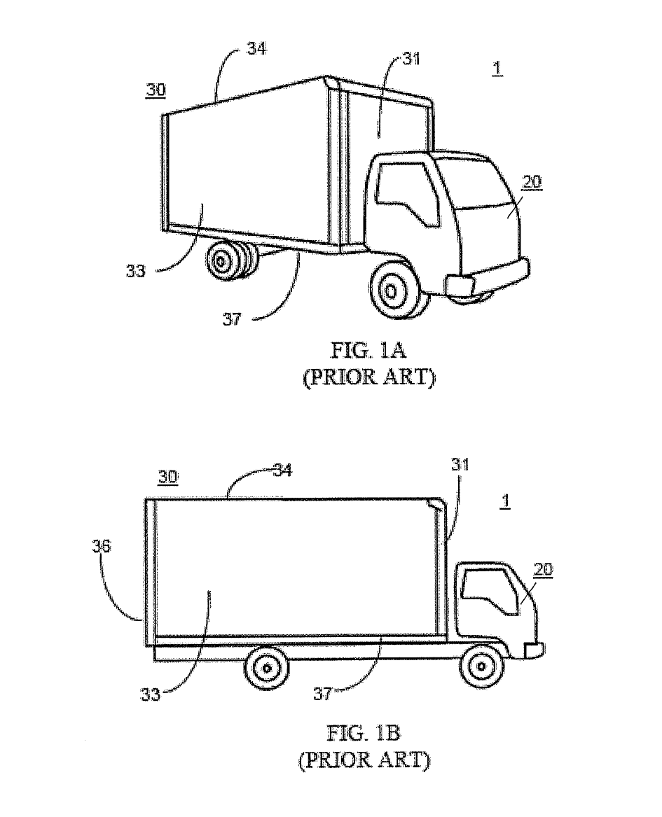

FIG. 1A and FIG. 1B show a typical vehicle 1 as a single unit truck, for example, having a cab 20 that houses the power system and space for an operator and a van type cargo area 30. The cargo area 30 has a front surface 31, left side surface 32 and right side surface 33, a top surface 34, a rear surface 36, and an undercarriage region 37. The undercarriage region 37 has, in combination, undercarriage structures 38 such as rotating wheels, brake systems, axles, and other various mechanical components. FIG. 1A shows an oblique front view and FIG. 1B shows a side view of a typical vehicle 1 with a cargo area 30.

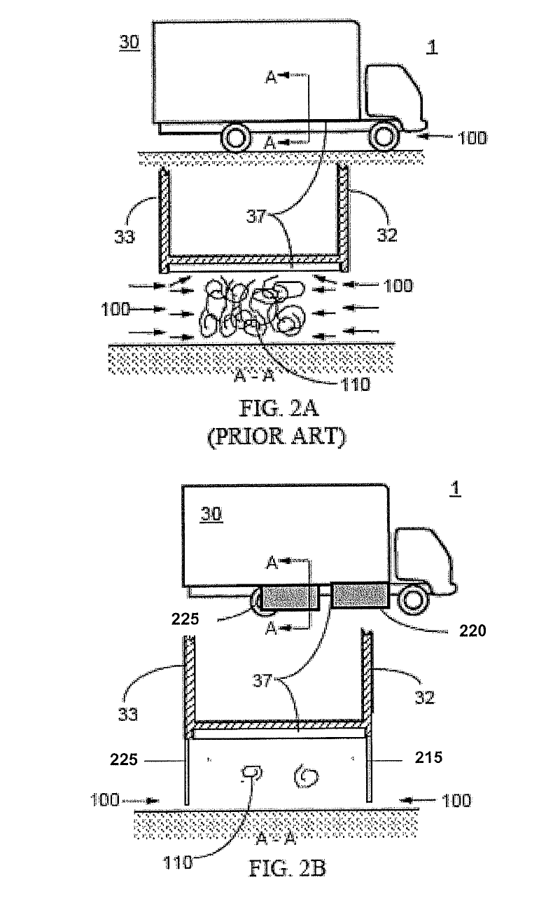

FIG. 2A shows flow patterns in the undercarriage region 37 of vehicle 1. FIG. 2B shows the change in air flow in the undercarriage region 37 with a fairing device 10 installed. Fairing device 10 includes a left forward panel system 210, a left aft panel system 215, a right forward panel system 220, and a right aft panel system 225. The panels 210, 215, 220, 225 are preferably substantially rectangular. The term “substantially rectangular” as used herein means that a generally rectangular shape can be identified having a perimeter with generally opposing upper and lower edges and generally opposing left and right edges. The term is intended to compass shapes that are, e.g., square, trapezoidal, or parallelogram and shapes having rounded edges or corners. In FIG. 2A and FIG. 2B, the airflow about the vehicle 1 and in the undercarriage region 37 is a free stream flow 100 represented by arrow-tipped lines and rotational, random, unsteady eddy flow 110.

When a vehicle 1 moves over a surface or road, the free stream flow 100 enters the undercarriage region 37 from the cab 20 and from the sides of the vehicle 1. The free stream flow 100 interacts with the various vehicle components and becomes unstructured and dynamic and includes random size and strength eddy flow 110. The dynamic, random eddy flow 110 in the undercarriage region 37 interacts with the undercarriage structures 38 (not shown) of vehicle 1 resulting in a large drag force.

FIG. 2B shows a cross-section view, in a plane perpendicular to the ground, of the undercarriage region 37 of a vehicle cargo area 30 and the left forward panel system 210 and left aft panel system 215. Not shown are the right forward panel system 220 and the right aft panel system 225. In the cross section A-A the left aft panel system 215 and the right aft panel system 225 are shown attached to the lower portion of the cargo area 30 and the undercarriage region 37. Again the undercarriage structures 38 are not shown. Each vehicle 1, fairing device 10 contains two primary surfaces for each side; a forward panel system 210, 220 and an aft panel system 215, 225. FIG. 2B also shows the undercarriage region 37 with the change in eddy flow 110 with the fairing device 10 installed. For a vehicle 1 with the fairing device 10 installed there is negligible eddy flow 110 and thus negligible undercarriage drag. The dramatic reduction in eddy flow 110 results from the control of the free stream flow 100 by both the forward panel systems 210, 220, and the aft panel systems 215, 225, of the fairing device 10. The forward panel systems 210, 220, and the aft panel systems 215, 225 efficiently redirect the flow, passing under and around the sides of the forward part of the vehicle 1, laterally outboard of the vehicle cargo area 30. The aft panel systems 215, 225, efficiently block the flow that would enter the undercarriage region 37 from the side of the vehicle 1.

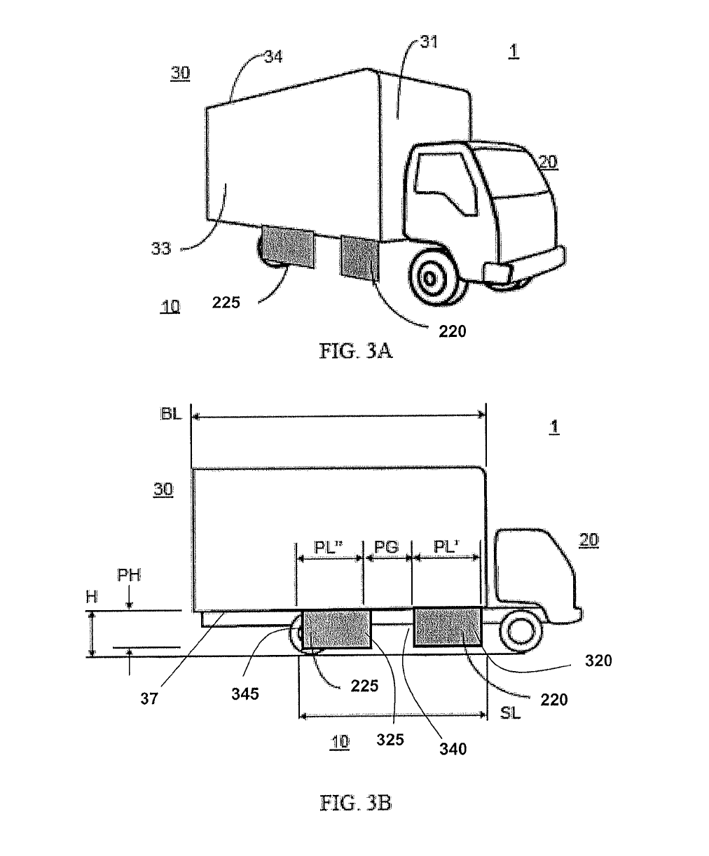

FIG. 3A and FIG. 3B show a vehicle 1, again a typical single unit truck. FIG. 3A shows an oblique front view and FIG. 3B shows a side view with a van cargo area 30 with the fairing device 10 installed. The fairing device 10 is comprised of two structures, a right forward panel system 220 and a right aft panel system 225 that extended downward from the vehicle undercarriage region 37. The panel width PH of each panel system 220, 225 is typically anywhere less than or equal to about 99% of the distance H from the lower surface of the undercarriage region 37 to the surface or road that the vehicle 1 is moving over. The panel width PH may be for example less than or equal to about 95% of the distance H, or between about 70% and 95% of distance H. Other suitable dimensions may also be used. Each of the two panel systems 220, 225 may be comprised of at least one or multiple panels distributed longitudinally. Shown in FIG. 3A and 3B is a two panel version of the fairing device 10 showing right forward panel system 220 and a right aft panel system 225, but not showing a left forward panel system 210 and a left aft panel system 215 which are mirror imaged on the left side of the vehicle 1. The description of these figures is for the fairing device 10 on the right side, but it can be applied to the left side as well. The forward portion of each forward panel, 220, 210, is approximately aligned in a plane that is parallel with the vehicle 1 centerline and has minimal forward projected area. The aft portion of each aft panel, 225, 215, of each structure is approximately aligned in a plane that is parallel with the vehicle centerline and has minimal forward projected area. The longitudinal length SL of the fairing device 10 is at least 30% of the vehicle cargo area 30 length BL and not greater than the length of the vehicle 1. Length SL of the fairing device 10 may be between about 30% and about 50% of the length BL, or greater than about 50% of the length BL. Other suitable dimensions may also be used. Of course, the fairing device 10 may be used with various configured cargo systems such as flat beds, tanks, reefers, and various size trucks and pull trailers or vehicles as well, in which the plane of side surfaces 32 or 33 may be somewhat notional. Each panel 210, 215, 220, 225 of the fairing device 10 has a width PH and a length PL. The panels 210, 215, 220, 225 are separated by a distance PG. The distance PG may be, for example, about 6 inches, at least about 2 feet, between about 2 feet and about 4 feet, between about 4 feet and about 6 feet, or greater than about 6 feet. Other suitable dimensions may also be used. The shown leading edge 320, 325 and trailing edge 340, 345 of each panel 220, 225 may be swept. This may be similar for the left side panels 210, 215 (not shown) as well. To facilitate access to the undercarriage region 37, each panel 210, 215, 220, 225 may be either removed through a quick disconnect mechanism or folded out of the way, so as to be substantially adjacent and proximate the undercarriage region 37 or side surfaces 32 and 33. The length PL and width PH of each panel, 220 and 225, is determined by the geometric characteristics, operational requirements and the maintenance requirements of the vehicle 1. In certain embodiments, length PL may be about 4 feet, between about 4 feet and about 6 feet, about 6 feet, about 8 feet, about 12 feet, about 14 feet, about 16 feet, about 18 feet, or greater than about 18 feet. Other suitable dimensions may also be used. It is desirable that each panel, 220, 225, reside between the aft most portion of the vehicle 1 and a point aft of the cab 20.

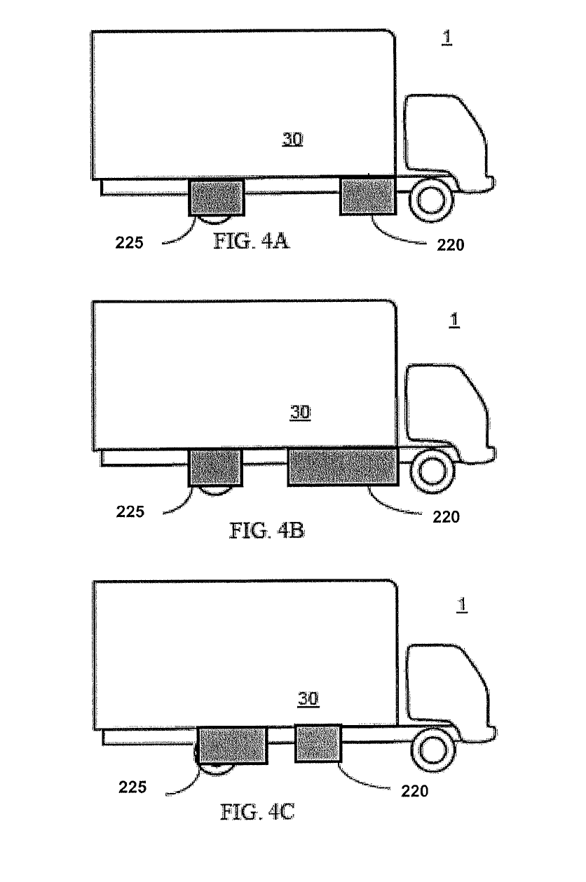

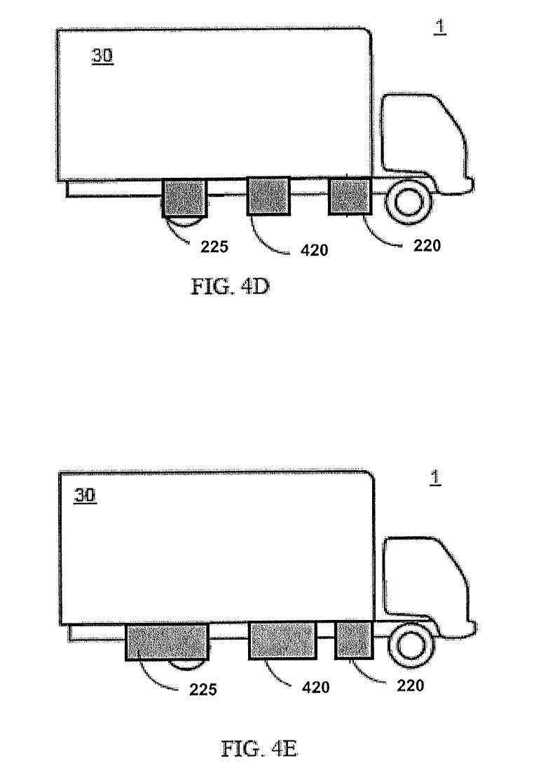

FIGS. 4A-4E shows a side view of a vehicle 1 as a single unit truck with several versions of the fairing device 10 installed. FIGS. 4A-4C show a two panel system of the right side of the fairing device 10 where the right forward panel system 220 may have a length PL that is greater than, less than, or equal to the PL of the right aft panel system 225. Also shown is a varying gap distance PG of panels 220 and 225 where the gap may be larger, smaller, or equal to the length PL of the panels 220, 225. FIG. 4D shows the right side of the vehicle 1 with three panels 220, 225 and a sequential panel 420 that may be placed at a desired distance between panels 220 and 225. Accordingly any panel length PL or panel gap PG may vary in relation to each other.

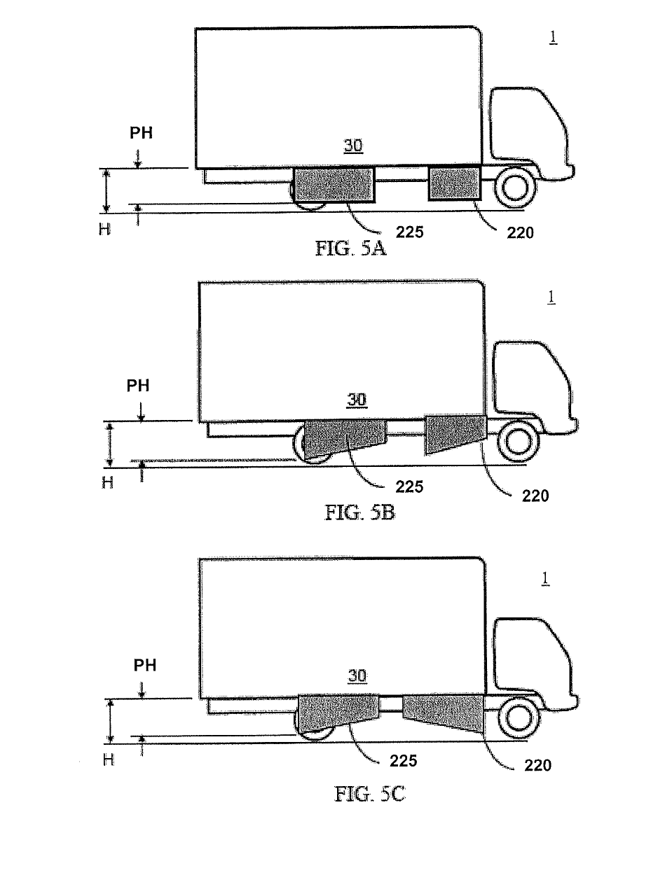

FIGS. 5A-5C shows a side view of a vehicle 1 with the fairing device 10 installed. FIG. 5A shows the right forward panel system 220 and the right aft panel system 225 with a panel width PH that is constant along the panel length PL. FIGS. 5B and 5C show different configurations of the right forward panel system 220 and the right aft panel system 225 with a varying panel width PH and panel gap PG along the length BL of the cargo area 30. The depicted panel width PH variation concepts shown are examples only. Additional concepts for panel width variation may also be considered. The example concepts shown (as well as other concepts) may be used on any of the panels 210, 215, 220, 225 comprising the fairing device 10.

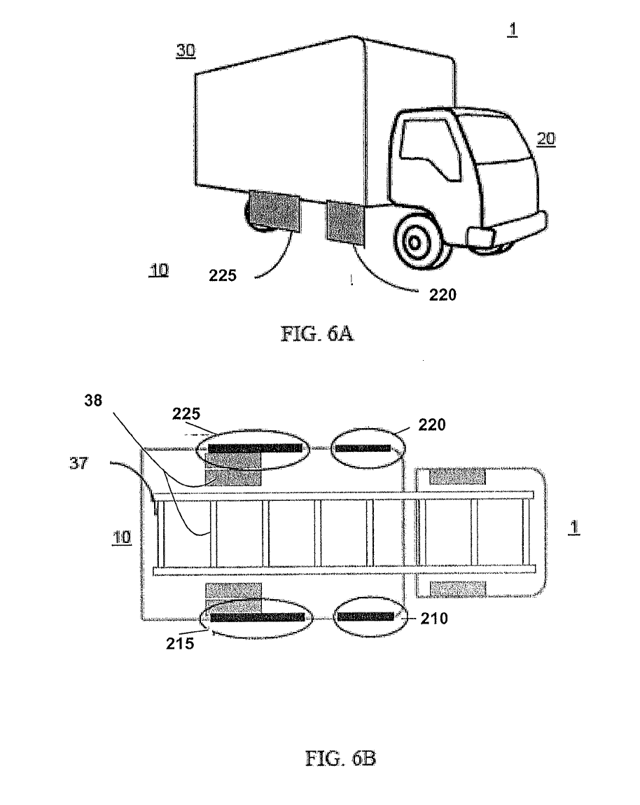

FIG. 6A shows the right side of a vehicle 1, with the fairing device 10 installed. FIG. 6B shows an undercarriage region 37 view with undercarriage structures 38 of a typical single unit truck with a bottom view of the fairing device 10 with four panels 210, 215, 220, 225 installed on the left and right side of the cargo area 30 respectively and approximately aligned in a plane that is parallel with the vehicle 1 centerline.

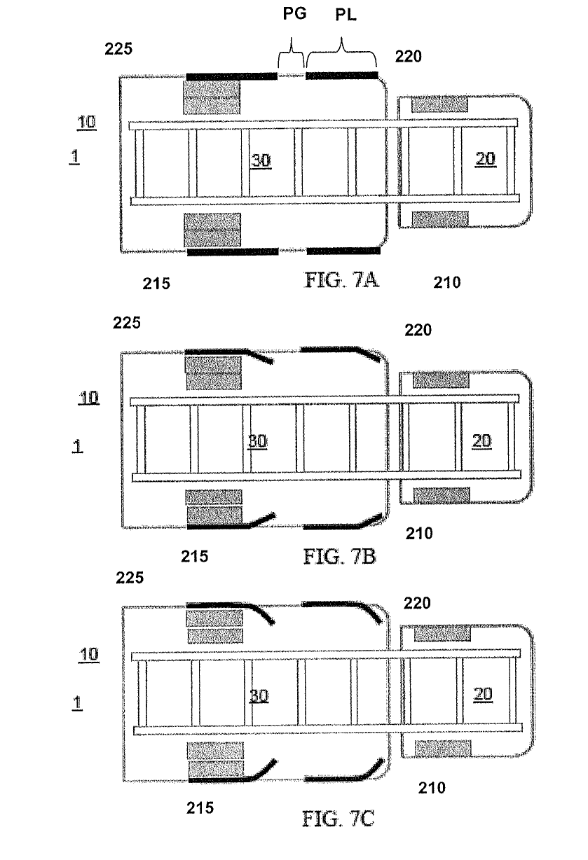

FIGS. 7A-7C shows an undercarriage region 37 view of a vehicle 1, with a variation in the shape and inward extension of the forward portion, of each panel 210, 215, 220, 225, of the fairing device 10. The forward portions of the panels may extend inward a lateral distance of about 4 inches, about 6 inches, or greater than about 6 inches. Other suitable dimensions may also be used. The depicted lengths and shape of the forward portion of each panel 210, 215, 220, 225 are examples only and an additional number of panels, panel lengths PL, panel forward shape, and panel gaps PG distance may also be considered, and may vary between longitudinally adjacent panels.

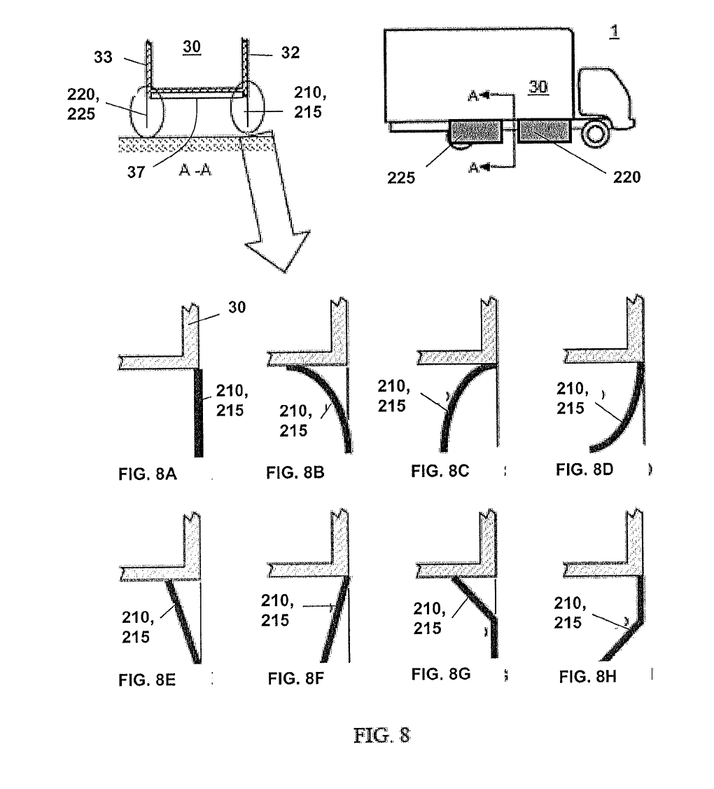

FIG. 8 shows a typical installation of the side panels 220, 225 on the right side of a single unit truck 2 with a cross section that shows the cargo area 30, left side surface 32, right side surface 33 and undercarriage region 37. FIGS. 8A-8H show eight vertical shape concepts that may make up the fairing design 10. Shown are concepts for mounting to the left side of a single unit truck vehicle 1, but should be considered as adaptable for the right side as well. FIG. 8A shows a left side panel 210, 215 that is constructed as a single vertical shape along the plane of the left side surface 32. The panel 210, 215 is of a single straight plane. FIG. 8B shows each panel 210, 215 that may be constructed as an outwardly curved panel with the mounting of the panel 210, 215 in the undercarriage region 37 inside the plane of the left side surface 32. FIG. 8C shows each panel may be constructed as an inwardly curved panel 210, 215. FIG. 8D shows each panel 210, 215 may be constructed as being mounted along the plane of the left side surface 32 in an inwardly curved panel. FIG. 8E shows each panel 210, 215 may be constructed as an outwardly angled linear or flat panel 210, 215 with an upper mounting in the undercarriage region 37 and sloping downwardly toward the plane of the left side surface 32. FIG. 8F shows each panel 210, 215 as an inwardly angled linear panel where the mounting of the panel 210, 215 may be along the plane of the left side surface 32 and sloping inwardly toward the vehicle 1 centerline. FIG. 8G shows each panel 210, 215 may be constructed as an outwardly bent panel with an inset upper edge mounting the panel in the undercarriage region 37 and extending outwardly from the vehicle 1 centerline, having a defined crease or bend and facing downward along the plane of the left side surface 32. FIG. 8H shows each panel 210, 215 may be constructed as an inwardly bent panel mounting along the plane of the left side surface 32 angling inwardly toward the vehicle 1 centerline and then facing downward. The depicted panel vertical shape concepts shown are examples only, additional panel shape concepts may also be considered. The example panel shape concepts shown as well as other shape concepts may be used on any or all panels 210, 215, 220, 225 of the fairing device 10.

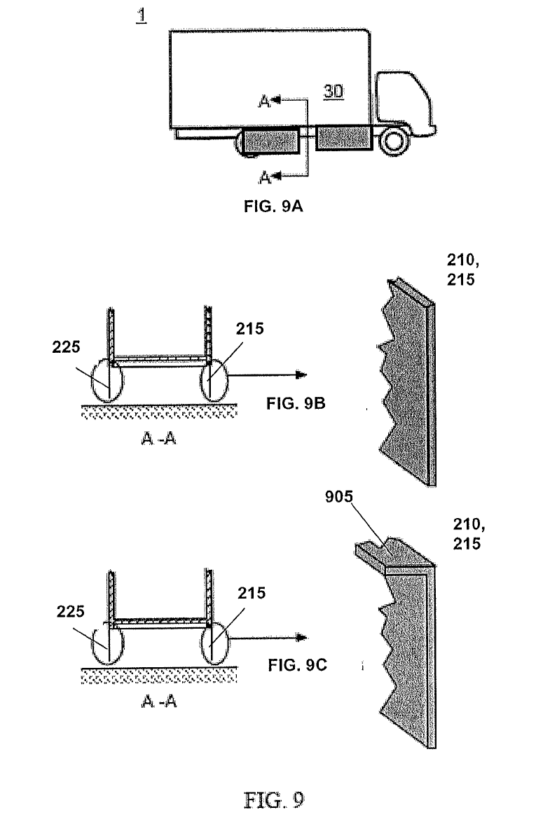

FIGS. 9B and 9C show two additional panel concepts for vehicle 1 (FIG. 9A). FIG. 9B shows that each panel 210, 215 may be constructed as a single vertical panel without an attachment element. FIG. 9C shows each panel 210, 215 may be constructed as an L shaped panel with an integrated upper attachment element 905. The depicted concepts shown are examples only, additional panel concepts may also be considered. The example panel concepts shown as well as other concepts may be used on any or all panels of the fairing device 10.

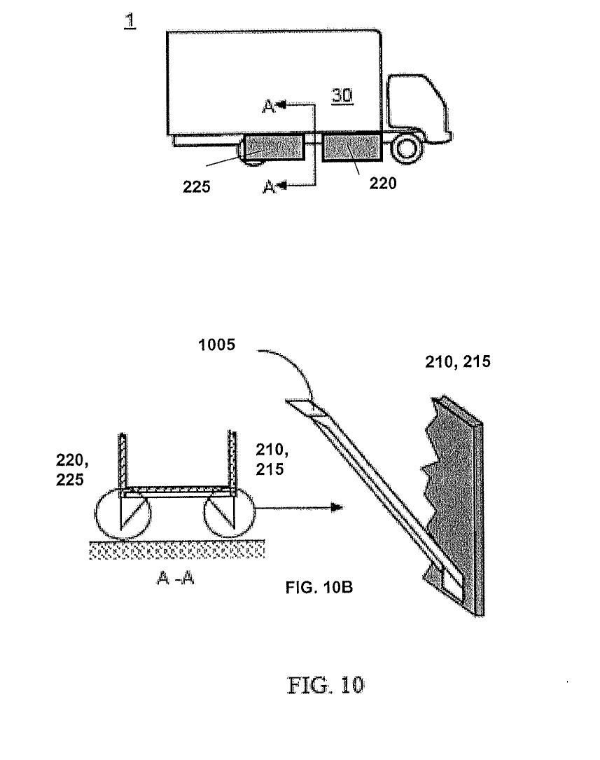

FIG. 10B shows a support concept which may be used for the fairing device 10 vehicle 1 (FIG. 10A). FIG. 10B shows a cross-section view A-A, in a plane perpendicular to the ground, of the undercarriage region 37 of a cargo area 30 with two panels 210, 215. The concept shown is for an angled bracket 1005 connected to the undercarriage region 37 of single unit truck 2 may be used to support each panel 210, 215. The angled bracket 1005 concept is an example only and may be an integral design of each panel 210, 215 where the angled bracket 1005 is a single molded part of panel 210, 215. Additional support concepts may also be considered. The example support concept shown as well as other support concepts may be used on any or all panels of the fairing device 10.

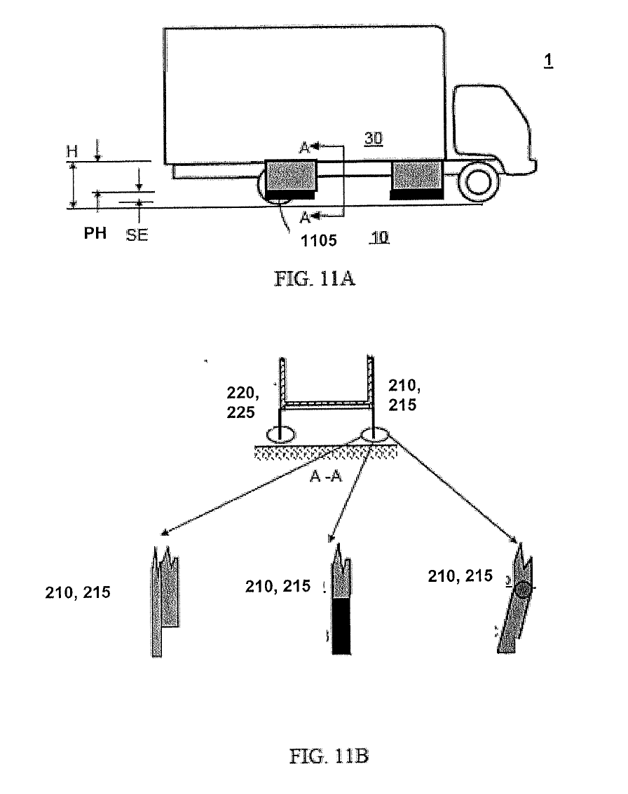

FIG. 11A shows a side view of a vehicle 1 with the fairing device 10 installed. FIG. 11A show the right side panels 220, 225 with alternate lower edge 1105 concepts. FIG. 11B show three representative concepts for the alternate lower edges, 1105. The alternate lower edges may be slidable (horizontally and vertically along the panel 220, 225), flexible, and/or spring loaded. Additional concepts may also be considered based upon operational, maintenance, and performance considerations. The alternate edge width SE is less than the device width PH and the combination of the alternate edge width SE and the device width PH is less than the distance from the undercarriage region 37 to the ground H.

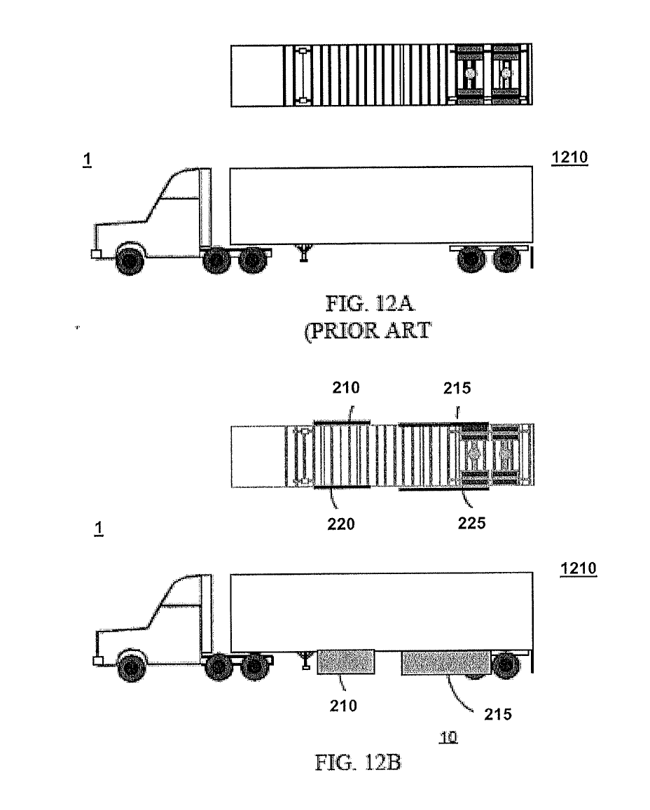

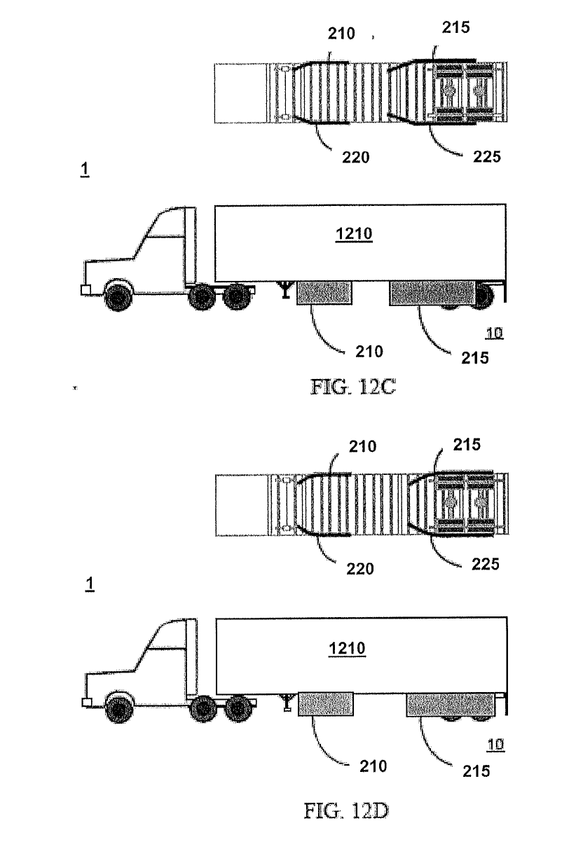

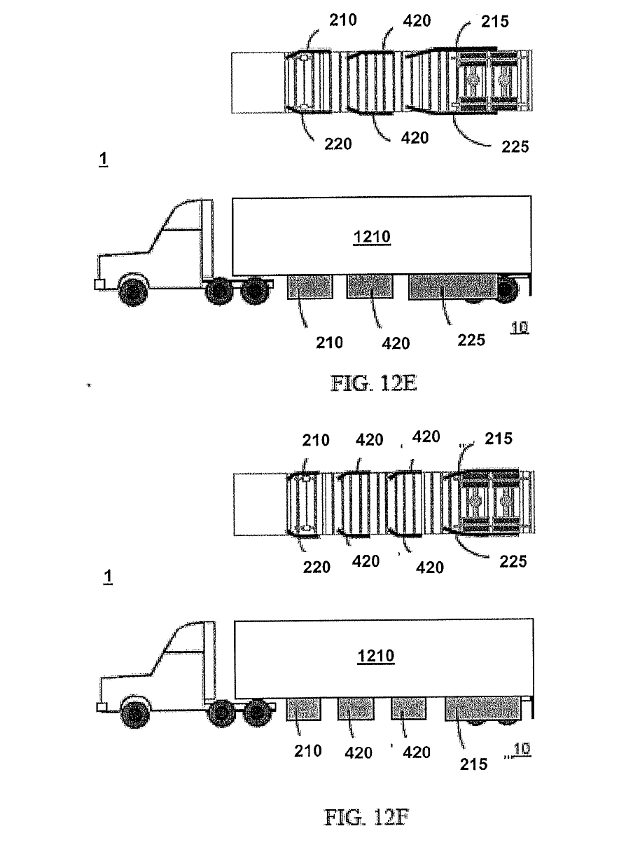

FIGS. 12A-12F show side and lower surface views of vehicle 1 shown as a typical tractor-trailer combination with a trailer 1210 with and without the fairing device 10 installed on the trailer 1210. The fairing device 10 extends downward from the trailer lower surface. FIG. 12B shows side and undercarriage region 37 views of the vehicle 1 with a fairing device 10 with panels 220, 225 and 210, 215 installed on the trailer 1210 right and left sides respectively. FIGS. 12C and 12D show side and undercarriage region 37 views of the vehicle 1 with a two-panel version of the fairing device 10 installed on the trailer 1210 where the leading edge 310, 315, 320, 325 of each panel 210, 215, 220, 225 is shaped to extend inward toward centerline of vehicle 1. FIG. 12E shows side and lower surface views of the vehicle 1 with a three-panel version with a sequential panel 420 installed on the trailer 1210 between panel 210 and 215. FIG. 12F shows side and lower surface views of vehicle 1 with a four-panel version with more than one sequential panel 420 installed between panels 210 and 215 on the trailer 1210. The depicted concepts are examples only, additional panel shapes, panel length PL, numbers of sequential panels 420, and panel gap PG distances may also be considered as elements of the fairing device 10. The example panel concepts shown in previous figures as well as other concepts may be used on any or all panels of the fairing device 10.

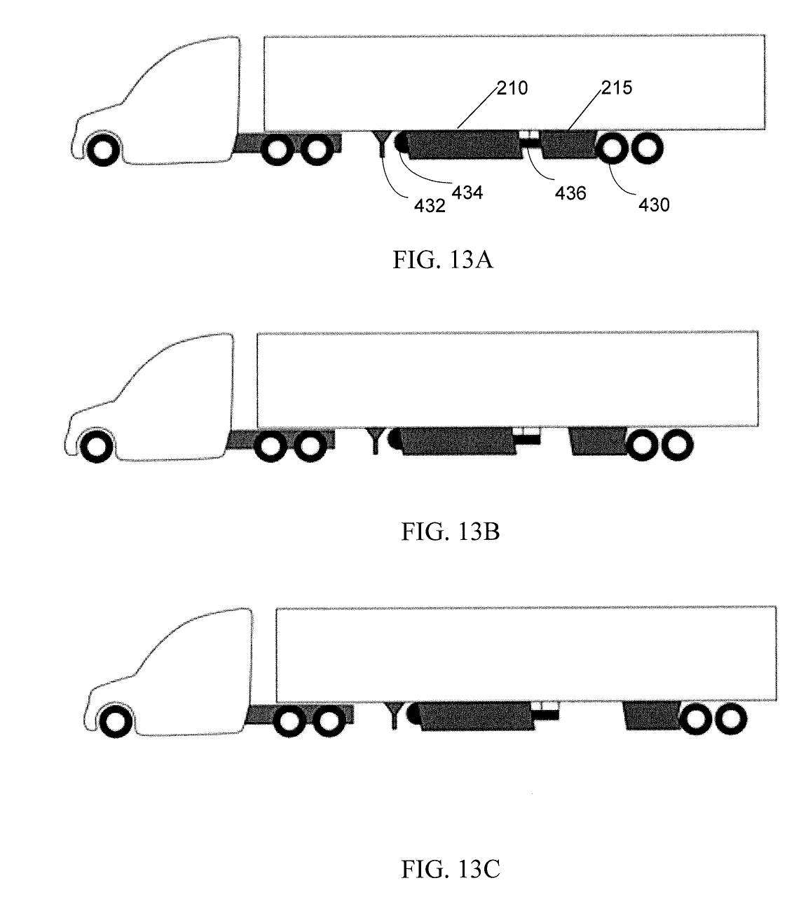

FIGS. 13A-13C show a typical tractor-trailer with the slider in three different positions. In 13A, the slider is in its forward-most position. In 13B, the slider is in a mid-position. In 13C, the slider is in its aft-most position. The aft panels are positioned such that a rear edge of each aft panel is positioned forward of, and in close proximity to, a front portion of the aft-most wheel and tire assembly 430. In the illustrated embodiment, the aft panels are secured to the slider and thus move in tandem with the slider. This configuration prevents a sizable gap from opening up between the aft panels and the wheel and tire assembly 430, thus preventing air flow from entering the undercarriage region immediately forward of the wheel and tire assembly. The aft panels can be configured such that no gap or only a small gap is formed. Such a gap may be for example less than about 6 inches. Shielding this area can be particularly important for reducing undercarriage drag. The illustrated configuration also permits ready access to the wheel and tire assembly for maintenance purposes regardless of the slider position. In the illustrated embodiment, the forward panels have angled forward and rear edges giving them a parallelogram shape. The rear edge of the aft panels may have a concave shape as shown that approximately follows the shape of the forward-most tire of the wheel and tire assembly, thereby permitting close positioning of the aft panels to wheel and tire assembly with no or minimal obstruction. The forward and aft panels are preferably positioned and sized to permit access to various systems such as landing gear 430, spare tire 432, and reefer 434 as shown. The lengths of the aft panels may be, for example, approximately 4 feet, between about 4 feet and 6 feet, approximately 6 feet, or greater than about 6 feet. Other suitable sizes may also be used. The lengths of the forward panels may be, for example, less than about 8 feet, about 8 feet, about 12 feet, about 14 feet, about 16 feet, about 18 feet, or greater than about 18 feet. Other suitable sizes may also be used.

From the description provided above, a number of features of the segmented-skirt aerodynamic fairing become evident. This approach provides a process to reduce the drag of a ground vehicle, and:
(a) uses flow control shaping to reduce undercarriage flow and reduce drag;
(b) reduces the aerodynamic drag and improves the operational efficiency of ground vehicles;
(c) reduces the aerodynamic drag and improves the fuel efficiency of ground vehicles;
(d) conserves energy and improves the operational efficiency of ground vehicles;
(e) reduces the aerodynamic drag without a significant geometric modification to existing ground vehicles.
(f) may be easily applied to any existing ground vehicle or designed into any new ground vehicle;
(g) may be efficiently operated with a limited number of components;
(h) permits the matching of complex surface shapes by the shaping and placement of the components;
(i) achieves large reductions in drag force with a large vertical spacing between the lower edge of the apparatus and the road surface;
(j) the structure, placement, and shape of each component may be adapted to meet specific performance or vehicle integration requirements;
(k) the shape of each surface may be linear or complex to meet specific performance or vehicle integration requirements;
(l) the lower edge shape of each surface may be linear or complex to meet specific performance or vehicle integration requirements;
(m) the trailing edge shape of each surface may be linear or complex to meet specific performance or vehicle integration requirements;
(n) each component of the device may be optimally positioned on the vehicle undercarriage;
(o) minimizes weight and volume requirements within the vehicle;
(p) has minimal maintenance requirements;
(q) has minimal impact on operational and use characteristics of the vehicle door system; and
(r) provides for maximum safety of vehicle operation.

Accordingly, the aerodynamic fairing device can be used to easily and conveniently reduce aerodynamic drag on any ground vehicle for the purposes of improving the operational performance of the vehicle. For example, ground vehicles may include buses, rail cars, automobiles, etc., so long as such vehicle would benefit from the fairing device's implementation of the flow control concepts and ground effect interference.

Although the description above contains many specifics, these should not be construed as limiting the scope of the invention but as merely providing illustrations of some of the presently preferred embodiments of the fairing device. For example, each panel surface can be composed of various planar shapes such as ellipsoid, quadratic, and the like; each panel surface can be rotated from the vertical axis or may be curvilinear surfaces that are parallel with the axis of the vehicle; the thickness and width of each panel can vary along the length; the material can be any light-weight and structurally sound material such as wood, plastic, metal, composites, and the like; the substrate can be any metal, wood, plastic, composite, rubber, ceramic, and the like; the application surface can be that of a metal, wood, plastic, composite, rubber, ceramic, and the like. The attachment and actuation hardware can be either conventional off the shelf or designed specifically for the device. Further, the fairing device may be incorporated or integrated within the structure of the vehicle, so as to require no separate attachment. The panels located in close proximity to a wheel assembly may attach to the undercarriage region or support structure for the wheel assembly and the panel may be used to cover the outward facing surface of the rotating portion of the wheel assembly. Additionally, for a truck trailer system where the trailer rear wheel assembly is movable in the longitudinal direction a panel of the fairing device may be attached to the longitudinally movable trailer wheel assembly so that the panel maintains its position relative to the wheel assembly.

The fairing device has been described relative to specific embodiments thereof and relative to specific vehicles, it is not so limited. The fairing device is considered applicable to any road vehicle including race cars automobiles, trucks, buses, trains, recreational vehicles and campers. The fairing device is also considered applicable to non-road vehicles such as hovercraft, watercraft, aircraft and components of these vehicles. It is to be understood that various modifications and variation of the specific embodiments described herein will be readily apparent to those skilled in the art in light of the above teachings without departing from the spirit and scope.

Thus, the scope of the invention should be determined by the appended claims and their legal equivalents, rather than by the examples given.

1. An apparatus for reducing the aerodynamic drag of a vehicle trailer body having a bottom defining an undercarriage region, a left side defining a left side surface, a right side defining a right side surface, the trailer further including a right aft-most wheel assembly, a left aft-most wheel assembly, and a sliding bogie configured to permit the right and left wheel assemblies to be slid longitudinally with respect to the trailer body, the trailer body being configured for transport over a road surface, the apparatus comprising:
a substantially rectangular left forward panel having a width (LFPH) and a length (LFPL);
a substantially rectangular left aft panel having a width (LAPH) and a length (LAPL);
a substantially rectangular right forward panel having a width (RFPH) and a length (RFPL);
a substantially rectangular right aft panel having a width (RAPH) and a length (RAPL);
wherein the left aft panel and left forward panel are configured to attach to a lower left portion of the trailer such that they extend downward from the undercarriage region, the left forward panel being positioned forward of the left aft panel, wherein the left aft panel and the left forward panel are approximately parallel to the left side surface of the trailer, wherein the right aft panel and right forward panel are configured to attach to a lower right portion of the trailer such that they extend downward from the undercarriage region, the right forward panel being positioned forward of the right aft panel, wherein the right aft panel and the right forward panel are approximately parallel to the right side surface of the trailer, wherein the width of each of the panels is less than or equal to about 95% of a distance between the trailer bottom surface and the road surface, wherein the left aft panel and the right aft panel are secured to the sliding bogie such that they move longitudinally with the sliding bogie, wherein the left aft panel is positioned longitudinally such that a forward edge of the left aft panel is located forward of the left wheel assembly, wherein the right aft panel is positioned longitudinally such that a forward edge of the right aft panel is located forward of the right wheel assembly, the left forward panel and the left aft panel being separated so as to define a first longitudinal gap having a length (LGL) that is greater than about 6 inches, the right forward panel and the right aft panel being separated so as to define a second longitudinal gap having a length (RGL) that is greater than about 6 inches;
wherein the apparatus is configured to reduce aerodynamic drag on the trailer by reducing airflow entering the undercarriage region from the sides of the trailer when the trailer is moving in a forward direction over the road surface.

2. The apparatus of claim 1, wherein the left forward panel and the right forward panel are configured to be positioned in a mirror-image configuration with respect to one another about an axis defined by a centerline running longitudinally through the trailer body.

3. The apparatus of claim 1, wherein the right aft panel is positioned longitudinally such that a rear edge of the right aft panel is located forward of, and in close proximity to, the forward portion of the right wheel assembly such that the right aft panel does not obstruct lateral access to the right wheel assembly, and wherein the left aft panel is positioned longitudinally such that a rear edge of the left aft panel is located forward of, and in close proximity to, the forward portion of the left wheel assembly such that the left aft panel does not obstruct lateral access to the left wheel assembly.

4. The apparatus of claim 1, wherein the length (LFPL) of the left forward panel, the length (LAPL) of the left aft panel, and the length (LGL) of the first gap together define a total left length (TLL), the total left length (TLL) being greater than or equal to about 30% of a trailer body length (BL), wherein the length (RFPL) of the right forward panel, the length (RAPL) of the right aft panel, and the length (RGL) of the second gap together define a total right length (TRL), the total right length (TRL) being greater than or equal to about 30% of the trailer body length (BL).

5. The apparatus of claim 1, wherein the length (LAPL) of the left aft panel and the length (RAPL) of the right aft panel are each greater than or equal to about 4 feet.

6. The apparatus of claim 1, wherein the length (LAPL) of the left aft panel and the length (RAPL) of the right aft panel are each about 6 feet.

7. The apparatus of claim 1, wherein the length (LAPL) of the left aft panel and the length (RAPL) of the right aft panel are each greater than or equal to about 6 feet.

8. The apparatus of claim 1, wherein the length (LFPL) of the left forward panel and the length (RFPL) of the right forward panel are each greater than or equal to about 6 feet.

9. The apparatus of claim 1, wherein the length (LFPL) of the left forward panel and the length (RFPL) of the right forward panel are each greater than or equal to about 12 feet.

10. The apparatus of claim 1, wherein the length (RGL) of the second gap and the length (LGL) of the first gap are each greater than or equal to about 2 feet.

11. The apparatus of claim 1, wherein the length (RGL) of the second gap and the length (LGL) of the first gap are each greater than or equal to about 4 feet.

12. The apparatus of claim 1, wherein the length (RGL) of the second gap and the length (LGL) of the first gap are each greater than or equal to about 6 feet.

13. The apparatus of claim 1, wherein the right forward panel and the left forward panel are each configured to slide longitudinally with respect to the trailer body to change their position.

14. The apparatus of claim 1, wherein a forward portion of the right aft panel and a forward portion of the left aft panel are each curved laterally inward so as to extend at least partially into the undercarriage region, the forward portions each defining a surface configured to divert air flow laterally outward from underneath the undercarriage region when the trailer is moving in a forward direction over the road surface.

15. The apparatus of claim 1, wherein the right aft panel is substantially parallelogram-shaped so that a bottom edge of the right aft panel is longitudinally offset aft from a top edge of the right aft panel, and wherein the left aft panel is substantially parallelogram-shaped so that a bottom edge of the left panel is longitudinally offset aft from a top edge of the left aft panel.

16. The apparatus of claim 1, further comprising a third substantially rectangular right panel and a third substantially rectangular left panel, the third right panel being positioned forward of the right forward panel and forming a longitudinal gap therebetween, the gap having a length of at least 6 inches, the third left panel being positioned forward of the left forward panel and forming a longitudinal gap therebetween, the gap having a length of at least 6 inches.

17. The apparatus of claim 1, wherein each of the panels is configured to attach to the bottom of the trailer.

18. The apparatus of claim 16, further comprising a plurality of angled brackets, each of said plurality of angled brackets being configured to attach to the bottom of the trailer and secure a corresponding panel in place.

19. An apparatus for reducing the aerodynamic drag of a ground vehicle having a body including a bottom defining an undercarriage region, a left side defining a left side surface, a right side defining a right side surface, the vehicle further including a right aft-most wheel assembly, a left aft-most wheel assembly, the vehicle being configured for transport over a road surface, the apparatus comprising:
a substantially rectangular left forward panel having a width (LFPH) and a length (LFPL);
a substantially rectangular left aft panel having a width (LAPH) and a length (LAPL);
a substantially rectangular right forward panel having a width (RFPH) and a length (RFPL);
a substantially rectangular right aft panel having a width (RAPH) and a length (RAPL);
wherein the left aft panel and left forward panel are configured to attach to a lower left portion of the vehicle body and extend downward from the undercarriage region, the left forward panel being positioned forward of the left aft panel, wherein the left aft panel and the left forward panel are approximately parallel to the left side surface of the vehicle body, wherein the right aft panel and right forward panel are configured to attach to a lower right portion of the vehicle and extend downward from the undercarriage region, the right forward panel being positioned forward of the right aft panel, wherein the right aft panel and the right forward panel are approximately parallel to the right side surface of the vehicle body, wherein the width of each of the panels is less than or equal to about 95% of a distance between the vehicle bottom surface and the road surface, wherein the left aft panel is positioned longitudinally such that a forward edge of the left aft panel is located forward of the left wheel assembly, wherein the right aft panel is positioned longitudinally such that a forward edge of the right aft panel is located forward of the right wheel assembly, the left forward panel and the left aft panel being separated by a longitudinal gap having a length (LGL) that is greater than about 6 inches, the right forward panel and the right aft panel being separated by a longitudinal gap having a length (RGL) that is greater than about 6 inches;
wherein the apparatus is configured to reduce aerodynamic drag on the vehicle by reducing airflow entering the undercarriage region from the sides of the vehicle body when the vehicle is moving in a forward direction over the road surface.

20. The apparatus of claim 19, wherein the right gap length (RGL) and left gap length (LGL) are each greater than or equal to about 6 inches.

21. The apparatus of claim 19, wherein the right aft panel is positioned longitudinally such that a rear edge of the right aft panel is located forward of, and in close proximity to, the forward portion of the right wheel assembly such that the right aft panel does not obstruct lateral access to the right wheel assembly, and wherein the left aft panel is positioned longitudinally such that a rear edge of the left aft panel is located forward of, and in close proximity to, the forward portion of the left wheel assembly such that the left aft panel does not obstruct lateral access to the left wheel assembly.

22. The apparatus of claim 19, wherein a forward portion of the right aft panel and a forward portion of the left aft panel are each curved laterally inward so as to extend at least partially into the undercarriage region, the forward portions each defining a surface configured to divert air flow laterally outward from underneath the undercarriage region when the vehicle is moving in a forward direction over the road surface.
